(19) United States
(12) Patent Application Publication
(10) Pub. No.: US 2025/0117754 A1
(43) Pub. Date: Apr. 10, 2025

(54) EPITAXIAL FILM DEFECT DETERMINATION

(71) Applicant: Applied Materials, Inc., Santa Clara, CA (US)

(72) Inventors: Ruiying Hao, San Jose, CA (US); Winston Chen, Los Altos, CA (US); Jenn-Yue Wang, Santa Clara, CA (US); Cathy Cai, Santa Clara, CA (US); Weizong Xu, Santa Clara, CA (US); Lifan Chen, Fremont, CA (US); Balasubramanian Pranatharthiharan, San Jose, CA (US)

(21) Appl. No.: 18/903,907

(22) Filed: Oct. 1, 2024

Related U.S. Application Data
(60) Provisional application No. 63/588,654, filed on Oct. 6, 2023.

(51) Int. Cl. G06Q 10/20; G06T 7/00; G06V 10/48; G06V 10/88

(52) U.S. Cl. CPC G06Q 10/20; G06T 7/0008; G06V 10/48; G06V 10/89; G06T 2207/10061; G06T 2207/20024; G06T 2207/20061

(57) ABSTRACT

A method includes obtaining, by a processing device, first image data of a substrate including an epitaxial film. The method further includes applying a frequency domain filter to the first image data to obtain filtered image data. The method further includes determining a number of epitaxial defects represented in the first image data by performing feature detection on the filtered image data. The method further includes performing a corrective action in view of the number of epitaxial defects.

### RELATED APPLICATIONS

This application claims the benefit of U.S. Provisional Patent Application No. 63/588,654, filed Oct. 6, 2023, entitled “EPITAXIAL FILM DEFECT DETERMINATION,” which is incorporated by reference herein.

### TECHNICAL FIELD

The present disclosure relates to methods associated with epitaxial films of manufactured devices. More particularly, the present disclosure relates to determinations of epitaxial film defects.

### BACKGROUND

Products may be produced by performing one or more manufacturing processes using manufacturing equipment. For example, semiconductor manufacturing equipment may be used to produce substrates via semiconductor manufacturing processes. Products are to be produced with particular properties, suited for a target application. Images of products (e.g., manufactured devices) may be taken, which may enhance understanding of device function, failure, performance, may be used for metrology or inspection, or the like. Products may include defects that may be characterized based on images of the products.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

In one aspect of the present disclosure, a method includes obtaining, by a processing device, first image data of a substrate including an epitaxial film. The method further includes applying a frequency domain filter to the first image data to obtain filtered image data. The method further includes determining a number of epitaxial defects represented in the first image data by performing feature detection on the filtered image data. The method further includes performing a corrective action in view of the number of epitaxial defects.

In another aspect of the present disclosure, a non-transitory machine-readable storage medium stores instructions which, when executed, cause a processing device to perform operations. The operations include obtaining first image data of a substrate including an epitaxial film. The operations include applying a frequency domain filter to the first image data. The operations further include determining a number of epitaxial defects represented in the first image data by performing feature detection. The operations further include performing a corrective action in view of the number of epitaxial defects.

In another aspect of the present disclosure, a system includes memory and a processing device coupled to the memory. The processing device is configured to obtain first image data of a substrate including an epitaxial film. The processing device is further configured to apply a frequency domain filter to the first image data. The processing device is further configured to determine a number of epitaxial defects represented in the first image data by performing feature detection. The processing device is further to perform a corrective action in view of the number of epitaxial defects.

### BRIEF DESCRIPTION OF THE DRAWINGS

The present disclosure is illustrated by way of example, and not by way of limitation in the figures of the accompanying drawings.

FIG. 1 is a block diagram illustrating an exemplary system architecture, according to some embodiments.

FIG. 2A depicts a block diagram of a system including an example data set generator for creating data sets for one or more supervised models, according to some embodiments.

FIG. 2B depicts a block diagram of an example data set generator for creating data sets for a supervised model configured to generate an indication of predicted epitaxial defect properties of a substrate, according to some embodiments.

FIG. 3 is a block diagram illustrating a system for generating output data, according to some embodiments.

FIG. 4A is a flow diagram of a method for generating a data set for a machine learning model, according to some embodiments.

FIG. 4B is a flow diagram of a method for performing a corrective action in view of epitaxial film defect determination, according to some embodiments.

FIG. 4C is a flow diagram of a method for training and utilizing a machine learning model in connection with epitaxial defect determination, according to some embodiments.

FIG. 5A is a block diagram of a flow for generating epitaxial film defect data, according to some embodiments.

FIG. 5B is an example epitaxial defect map of a substrate, according to some embodiments.

FIG. 6 is a block diagram illustrating a computer system, according to some embodiments.

### DETAILED DESCRIPTION

Described herein are technologies related to identifying, determining, and classifying defects in epitaxial films of substrates. Manufacturing equipment is used to produce products, such as substrates (e.g., wafers, semiconductors). Manufacturing equipment may include a manufacturing or processing chamber to separate the substrate from the environment. The properties of produced substrates are to meet target values to facilitate specific functionalities. Manufacturing parameters are selected to produce substrates that meet the target property values. Target property values may include target defect parameters, such as a target maximum number of defects, target maximum defect density, target count of density of two or more types of defects, etc. Many manufacturing parameters (e.g., hardware parameters, process parameters, etc.) contribute to the properties of processed substrates. Manufacturing systems may control parameters by specifying a set point for a property value and receiving data from sensors disposed within the manufacturing chamber, and making adjustments to the manufacturing equipment until the sensor readings match the set point. In some embodiments, trained machine learning models are utilized to improve performance of manufacturing equipment and/or improve performance of the manufactured substrates.

Classifying, counting, and determining the location of defects induced by a substrate manufacturing operation enables improvement to the manufacturing operation, improvements to the manufacturing equipment, improvements to substrate design, etc. Substrates may include epitaxial films. An epitaxial film is a crystalline layer of material deposited on a substrate that is also crystalline. In some cases, the arrangement of the epitaxial film (e.g., based on the lattice characteristics of the deposited material) aligns with the arrangement of the underlying substrate. In some cases, a deposited material may have different lattice properties than the underlying material, which may cause defects to form in the epitaxial film. Epitaxial films may have defects that are not found in other types of deposition processes, including dislocations (e.g., deviations from a regular atomic arrangement along a line), point defects (e.g., related to missing or extra atoms in the crystal lattice), stacking faults (e.g., related to interruptions in the regular stacking sequence of crystal planes), impurities interrupting regular lattice structures, underlying lattice defects causing defects in arrangement of subsequent crystal layers, etc. Common manifestations of epitaxial defects include pits (e.g., small roughly circular defects present in substrate images) and cross hatching (e.g., series of parallel lines present in images of the substrate).

In some cases, determination of epitaxial defects may be performed manually utilizing a couponing method. In couponing, a portion of a substrate (e.g., semiconductor wafer) may be designed or designated to test for epitaxial defects. The coupon portions may be removed (e.g., cut) from the substrate. The coupon portions may be checked for epitaxial defects. In some cases, coupons are relatively small compared to the substrate. Coupons may be expensive to generate, separate from the remainder of the substrate, test, etc. For example, classifying epitaxial defects may include manual review of one or more images of coupons by a subject matter expert, which may be time consuming, expensive, and potentially inaccurate. Further, in some cases, coupons cannot be removed from certain substrates, reducing the applicability of couponing techniques in epitaxial film defect detection.

Epitaxial defects may be small, e.g., on the order of nanometers to micrometers. Determining locations of epitaxial defects may include subject matter expert review of images of resolution such that these defects are visible. In some cases, a substrate of interest that includes and epitaxial film may many orders of magnitude larger than epitaxial defects (e.g., related to defects in a crystal lattice of the film). For example, a substrate may have a diameter of 300 mm. Under such conditions, providing a mapping of epitaxial defects of a large enough portion of a substrate to confidently infer defect properties of the substrate may be prohibitively expensive, time consuming, inconvenient, or impossible. For example, thousands of images may be used to image the entire surface of a substrate, which may involve many hours of defect classification, defect counting, etc., by trained users to generate any actionable insight related to epitaxial defects. The associated time, expertise, and cost commitment may be prohibitive for improving a manufacturing system based on epitaxial defects.

Systems, devices, and methods of the present disclosure may address one or more shortcomings of conventional systems for epitaxial film defects. In some embodiments, image data of a substrate including an epitaxial film is generated. The image data may be generated via a number of different imaging techniques. Imaging techniques may include optical microscopy, scanning electron microscopy, transmission electron microscopy, or other imaging techniques. In some embodiments, the substrate may be silicon. The epitaxial film may be a material with different lattice properties than the underlying substrate.

In some embodiments, epitaxial defects may be decorated by performing etching operations. Epitaxial defects may be places where crystal structure of the epitaxial film is interrupted, disrupted, or otherwise disturbed. Epitaxial defects may be more sensitive to etching conditions (e.g., plasma etching, chemical etching, etc.) than other locations of an epitaxial film. By performing an etch operation, epitaxial defects may be more clearly imaged by one or more selected imaging techniques.

In some embodiments, one or more pre-processing steps may be performed to adjust the image data of the substrate. For example, artifact removal, image smoothing or sharpening operations, noise reduction techniques such as gaussian blur, or the like, may be performed on the image data.

In some embodiments, a spatial image may be transformed to a frequency domain. Transformation to the frequency domain may be performed by performing a Fourier transform, a Fourier series decomposition, application of a fast Fourier transform algorithm, or the like. The frequency domain image data may have a frequency domain filter applied to it, for example to improve detection of a target type of defect.

In some embodiments, a number of epitaxial defects may be determined by a processing device. Determination of the number of epitaxial defects may be performed by one or more feature detection methods. For example, Hough transform operations may be performed to detect roughly circular etch pits, contour detection operations may be performed to detect cross hatching, etc. Further, densities of various types of defects may be determined based on defect counts. Distribution of defects of target types may be determined based on imaged locations, defect counts, defect densities, etc.

Systems of the present disclosure provide technological advantages over conventional solutions. Imaging may be performed by a non-destructive method, e.g., optical microscopy, which provides benefits over conventional couponing methods. Images may be performed by capturing an image of the substrate using optical microscopy. Further, automatic detection, classification, and analysis of defects by a processing device may be performed, which may be performed more quickly, with less user input, fewer opportunities for user error, less input by subject matter experts, etc., than manual classification, counting, and/or further analysis of epitaxial defects.

In one aspect of the present disclosure, a method includes obtaining, by a processing device, first image data of a substrate including an epitaxial film. The method further includes applying a frequency domain filter to the first image data to obtain filtered image data. The method further includes determining a number of epitaxial defects represented in the first image data by performing feature detection on the filtered image data. The method further includes performing a corrective action in view of the number of epitaxial defects.

In another aspect of the present disclosure, a non-transitory machine-readable storage medium stores instructions which, when executed, cause a processing device to perform operations. The operations include obtaining first image data of a substrate including an epitaxial film. The operations include applying a frequency domain filter to the first image data. The operations further include determining a number of epitaxial defects represented in the first image data by performing feature detection. The operations further include performing a corrective action in view of the number of epitaxial defects.

In another aspect of the present disclosure, a system includes memory and a processing device coupled to the memory. The processing device is configured to obtain first image data of a substrate including an epitaxial film. The processing device is further configured to apply a frequency domain filter to the first image data. The processing device is further configured to determine a number of epitaxial defects represented in the first image data by performing feature detection. The processing device is further to perform a corrective action in view of the number of epitaxial defects.

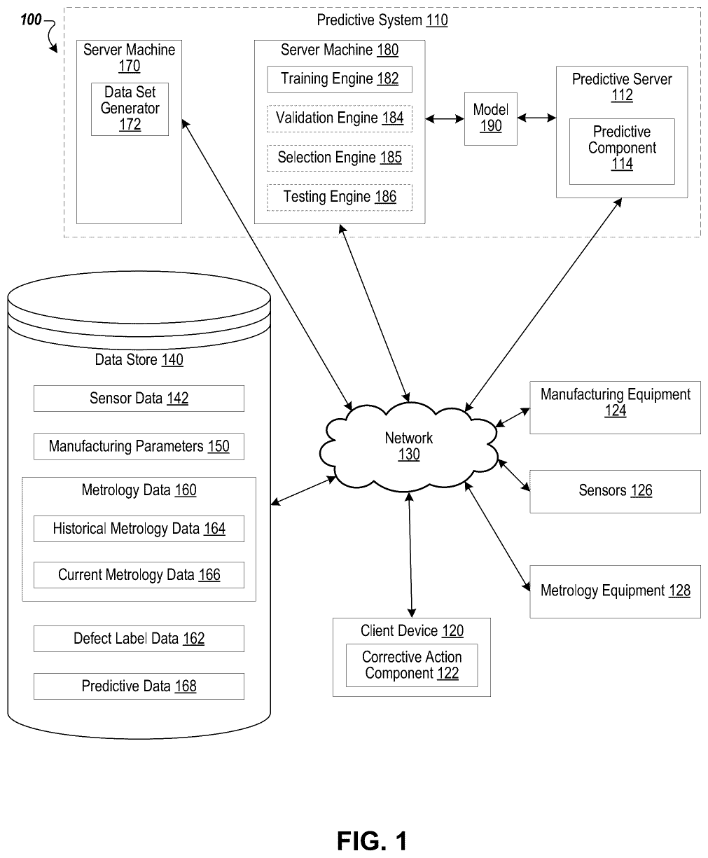

FIG. 1 is a block diagram illustrating an exemplary system 100 (exemplary system architecture), according to some embodiments. The system 100 includes a client device 120, manufacturing equipment 124, sensors 126, metrology equipment 128, predictive server 112, and data store 140. The predictive server 112 may be part of predictive system 110. Predictive system 110 may further include server machines 170 and 180.

Sensors 126 may provide sensor data 142 associated with manufacturing equipment 124 (e.g., associated with producing, by manufacturing equipment 124, corresponding products, such as substrates). Sensor data 142 may be used to ascertain equipment health and/or product health (e.g., product quality). Manufacturing equipment 124 may produce products following a recipe or performing runs over a period of time. In some embodiments, sensor data 142 may include values of one or more of optical sensor data, spectral data, temperature (e.g., heater temperature), spacing (SP), pressure, High Frequency Radio Frequency (HFRF), radio frequency (RF) match voltage, RF match current, RF match capacitor position, voltage of Electrostatic Chuck (ESC), actuator position, electrical current, flow, power, voltage, etc. Sensor data 142 may include historical sensor data and current sensor data. Current sensor data may be associated with a product currently being processed, a product recently processed, a number of recently processed products, etc. Historical sensor data may include data stored associated with previously produced products. Historical sensor data and/or current sensor data may include attribute data, e.g., labels of manufacturing equipment ID or design, sensor ID, type, and/or location, label of a state of manufacturing equipment, such as a present fault, service lifetime, etc.

Sensor data 142 may be associated with or indicative of manufacturing parameters such as hardware parameters (e.g., hardware settings or installed components, e.g., size, type, etc.) of manufacturing equipment 124 or process parameters (e.g., heater settings, gas flow, etc.) of manufacturing equipment 124. Data associated with some hardware parameters and/or process parameters may, instead or additionally, be stored as manufacturing parameters 150, which may include historical manufacturing parameters (e.g., associated with historical processing runs) and current manufacturing parameters. Manufacturing parameters 150 may be indicative of input settings to the manufacturing device (e.g., heater power, gas flow, etc.). Sensor data 142 and/or manufacturing parameters 150 may be provided while the manufacturing equipment 124 is performing manufacturing processes (e.g., equipment readings while processing products). Sensor data 142 may be different for each product (e.g., each substrate). Substrates may have property values (film thickness, film strain, etc.) measured by metrology equipment 128, e.g., measured at a standalone metrology facility. Metrology data 160 may be a component of data store 140. Metrology data 160 may include historical metrology data 164 (e.g., metrology data associated with previously processed products). Metrology data 160 may include current metrology data 166 (e.g., measurement data of one or more target substrates, one or more substrates of interest, or the like). In some embodiments, current metrology data 166 may be provided to one or more processing devices for performance of epitaxial film defect determination. In some embodiments, current metrology data 166 may be provided to one or more trained machine learning models for epitaxial film defect determination.

In some embodiments, metrology data 160 may be provided without use of a standalone metrology facility, e.g., in-situ metrology data (e.g., metrology or a proxy for metrology collected during processing), integrated metrology data (e.g., metrology or a proxy for metrology collected while a product is within a chamber or under vacuum, but not during processing operations), inline metrology data (e.g., data collected after a substrate is removed from vacuum), etc. Metrology data 160 may include current metrology data 166 (e.g., metrology data associated with a product currently or recently processed).

Metrology equipment 128 may include imaging instruments, e.g., for performing substrate imaging techniques. Metrology data 160 may include image data generated by imaging instruments of metrology equipment 128. Imaging techniques performed by metrology equipment 128 may include one or more optical microscopes, scanning electron microscopes, transmission electron microscopes, or the like.

In some embodiments, sensor data 142, metrology data 160, or manufacturing parameters 150 may be processed (e.g., by the client device 120 and/or by the predictive server 112). Processing of the sensor data 142 may include generating and/or detecting features. In some embodiments, the features are a pattern in the sensor data 142, metrology data 160, and/or manufacturing parameters 150 (e.g., slope, width, height, peak, etc.) or a combination of values from the sensor data 142, metrology data, and/or manufacturing parameters (e.g., power derived from voltage and current, etc.). In some embodiments, features are shapes or relationships between portions of image data, for example circles indicative of epitaxial etch pits, contour lines indicative of epitaxial cross hatching, etc. Sensor data 142, manufacturing parameters 150, and/or metrology data 160 may include features and the features may be used by predictive component 114 for performing signal processing and/or for obtaining predictive data 168 for performance of a corrective action.

Each instance (e.g., set) of sensor data 142 may correspond to a product (e.g., a substrate), a set of manufacturing equipment, a type of substrate produced by manufacturing equipment, or the like. Each instance of metrology data 160 and manufacturing parameters 150 may likewise correspond to a product, a set of manufacturing equipment, a type of substrate produced by manufacturing equipment, or the like. The data store may further store information associating sets of different data types, e.g., information indicative that a set of sensor data, a set of metrology data, and a set of manufacturing parameters are all associated with the same product, manufacturing equipment, type of substrate, etc.

Predictive system 110 may be utilized to generate predictive data 168. Predictive data 168 may be generated by performing image processing operations on image data of one or more substrates. Predictive data 168 may be data indicative of epitaxial defects of a substrate. Predictive data 168 may be indicative of classification, count, locations, density, severity, etc., of epitaxial defects of one or more substrates. Predictive data 168 may be generated by performing feature detection operations on image data associated with one or more substrates. Operations for determining epitaxial defects of substrates may be performed by predictive server 112, predictive component 114, etc.

In some embodiments, predictive system 110 may be utilized to generate predictive data 168 using one or more trained machine learning models. In some embodiments, predictive system 110 may generate predictive data 168 using supervised machine learning. Supervised machine learning refers to operations associated with a machine learning model that was provided with labeled training data, such as image data labeled by counts of epitaxial defects. In some embodiments, predictive system 110 may generate predictive data 168 using unsupervised machine learning Unsupervised machine learning refers to operations associated with a machine learning model that was trained using unlabeled input. Unsupervised machine learning operations may include clustering results, principle component analysis, anomaly detection, etc. In some embodiments, predictive system 110 may generate predictive data 168 using semi-supervised learning (e.g., training data may include a mix of labeled and unlabeled data, etc.).

Client device 120, manufacturing equipment 124, sensors 126, metrology equipment 128, predictive server 112, data store 140, server machine 170, and server machine 180 may be coupled to each other via network 130 for generating predictive data 168 to perform corrective actions. In some embodiments, network 130 may provide access to cloud-based services. Operations performed by client device 120, predictive system 110, data store 140, etc., may be performed by virtual cloud-based devices.

In some embodiments, network 130 is a public network that provides client device 120 with access to the predictive server 112, data store 140, and other publicly available computing devices. In some embodiments, network 130 is a private network that provides client device 120 access to manufacturing equipment 124, sensors 126, metrology equipment 128, data store 140, and other privately available computing devices. Network 130 may include one or more Wide Area Networks (WANs), Local Area Networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

Client device 120 may include computing devices such as Personal Computers (PCs), laptops, mobile phones, smart phones, tablet computers, netbook computers, network connected televisions (“smart TV”), network-connected media players (e.g., Blu-ray player), a set-top-box, Over-the-Top (OTT) streaming devices, operator boxes, etc. Client device 120 may include a corrective action component 122. Corrective action component 122 may receive user input (e.g., via a Graphical User Interface (GUI) displayed via the client device 120) of an indication associated with manufacturing equipment 124. In some embodiments, corrective action component 122 transmits the indication to the predictive system 110, receives output (e.g., predictive data 168) from the predictive system 110, determines a corrective action based on the output, and causes the corrective action to be implemented. In some embodiments, corrective action component 122 obtains sensor data 142 (e.g., current sensor data 146) associated with manufacturing equipment 124 (e.g., from data store 140, etc.) and provides sensor data 142 (e.g., current sensor data 146) associated with the manufacturing equipment 124 to predictive system 110.

In some embodiments, corrective action component 122 may retrieve current metrology data 166 (e.g., one or more images of a substrate of interest, possibly including indications of epitaxial defects). Corrective action component 122 may provide the current metrology data 166 to predictive system 110 for determining the presence of epitaxial defects of the substrate. Predictive system 110 may utilize image processing, feature detection operations, image filtering, frequency domain transformations, and other techniques for making determinations in association with the metrology data and epitaxial defects. Predictive system 110 may provide one or more images of a substrate to a trained machine learning model (e.g., model 190) for making determinations in association with epitaxial defects of the substrate. In some embodiments, model 190 may represent one or more physics-based, image processing, or machine learning models. In some embodiments, model 190 may instead or additionally be configured to make predictions (e.g., generate predictive data 168) indicative of portions of the substrate that were not imaged. For example, model 190 may be configured to predict properties (e.g., epitaxial defect locations and/or classifications) in portions of the substrate that were not imaged, based on image data of portions of the substrate that were imaged.

In some embodiments, predictive data 168 generated by predictive system 110 may include an indication of a corrective action to be performed. In some embodiments, corrective action component 122 receives an indication of a corrective action from the predictive system 110 and causes the corrective action to be implemented. Each client device 120 may include an operating system that allows users to one or more of generate, view, or edit data (e.g., indication associated with manufacturing equipment 124, corrective actions associated with manufacturing equipment 124, etc.).

In some embodiments, metrology data 160 (e.g., historical metrology data 164) corresponds to historical property data of products and predictive data 168 is associated with predicted property data. Historical metrology data 164 may correspond to products processed using manufacturing parameters and/or recipes associated with historical sensor data and historical manufacturing parameters. Predictive data 168 may include analysis performed on metrology data to generate additional insight into performance of a manufacturing system, chamber, recipe, substrate, etc. In some embodiments, predictive data 168 is or includes predicted metrology data (e.g., virtual metrology data, virtual synthetic microscopy images) of the products to be produced or that have been produced according to conditions recorded as current sensor data, current measurement data, current metrology data and/or current manufacturing parameters. In some embodiments, predictive data 168 is or includes an indication of any abnormalities (e.g., abnormal products, abnormal components, abnormal manufacturing equipment 124, abnormal energy usage, etc.) and optionally one or more causes of the abnormalities. In some embodiments, predictive data 168 is an indication of change over time or drift in some component of manufacturing equipment 124, sensors 126, metrology equipment 128, and the like. In some embodiments, predictive data 168 is an indication of an end of life of a component of manufacturing equipment 124, sensors 126, metrology equipment 128, or the like. In some embodiments, predictive data 168 is an indication of progress of a processing operation being performed, e.g., to be used for process control.

Performing manufacturing processes that result in defective products can be costly in time, energy, products, components, manufacturing equipment 124, the cost of identifying the defects and discarding the defective product, additional environmental impact incurred by the manufacturing, characterization, and/or disposal processes, etc. By inputting current metrology data 166 indicative of epitaxial defects into predictive system 110, receiving output of predictive data 168, and performing a corrective action based on the predictive data 168, system 100 can have the technical advantage of avoiding the cost of producing, identifying, and discarding defective products. For example, after deposition of an epitaxial film, but before additional manufacturing steps to produce a finished product, a substrate may be screened by utilizing imaging data to determine whether epitaxial defects of the substrate fall within a target threshold (e.g., of frequency, density, location, classification, etc.). Substrates which do not meet target performance thresholds may be excluded from further processing, avoiding costs associated with generating defective products.

Performing manufacturing processes that result in failure of the components of the manufacturing equipment 124 can be costly in downtime, damage to products, damage to equipment, express ordering replacement components, etc. By inputting current metrology data 166 into predictive system 110, receiving output of predictive data 168, and performing corrective action (e.g., predicted operational maintenance, such as replacement, processing, cleaning, etc. of components) based on the predictive data 168, system 100 can have the technical advantage of avoiding the cost of one or more of unexpected component failure, unscheduled downtime, productivity loss, unexpected equipment failure, product scrap, or the like. Monitoring the performance over time of components, e.g. manufacturing equipment 124, sensors 126, metrology equipment 128, and the like, may provide indications of degrading, drifting, and/or aging components.

Manufacturing parameters may be suboptimal for producing product which may have costly results of increased resource (e.g., energy, coolant, gases, etc.) consumption, increased amount of time to produce the products, increased component failure, increased amounts of defective products, increased environmental impact, etc. By inputting indications of metrology into predictive system 110, receiving output of predictive data 168, and performing a corrective action of updating manufacturing parameters (e.g., setting optimal manufacturing parameters), system 100 can have the technical advantage of using optimal manufacturing parameters (e.g., hardware parameters, process parameters, optimal design) to avoid costly results of suboptimal manufacturing parameters.

Corrective actions may be associated with one or more of Computational Process Control (CPC), Statistical Process Control (SPC) (e.g., SPC on electronic components to determine process in control, SPC to predict useful lifespan of components, SPC to compare to a graph of 3-sigma, etc.), Advanced Process Control (APC), model-based process control, preventative operative maintenance, design optimization, updating of manufacturing parameters, updating manufacturing recipes, feedback control, machine learning modification, or the like.

In some embodiments, the corrective action includes providing an alert (e.g., an alarm to stop or not perform the manufacturing process if the predictive data 168 indicates a predicted abnormality, such as an abnormality of the product, a component, or manufacturing equipment 124). In some embodiments, a machine learning model is trained to monitor the progress of a processing run (e.g., monitor in-situ sensor data to predict if a manufacturing process has reached completion). In some embodiments, the machine learning model may send instructions to end a processing run when the model determines that the process is complete. In some embodiments, the corrective action includes providing feedback control (e.g., modifying a manufacturing parameter responsive to the predictive data 168 indicating a predicted abnormality). In some embodiments, performance of the corrective action includes causing updates to one or more manufacturing parameters. In some embodiments, the corrective action includes excluding one or more substrates from further processing, flagging one or more substrates for additional metrology or other investigation, or the like (e.g., substrate screening). In some embodiments, performance of the corrective action may include scheduling and/or performing one or more maintenance operations, including component cleaning or replacement, chamber cleaning, chamber seasoning, etc. In some embodiments performance of a corrective action may include retraining a machine learning model associated with manufacturing equipment 124. In some embodiments, performance of a corrective action may include training a new machine learning model associated with manufacturing equipment 124.

Manufacturing parameters 150 may include hardware parameters (e.g., information indicative of which components are installed in manufacturing equipment 124, indicative of component replacements, indicative of component age, indicative of software version or updates, etc.) and/or process parameters (e.g., temperature, pressure, flow, rate, electrical current, voltage, gas flow, lift speed, etc.). In some embodiments, the corrective action includes causing preventative operative maintenance (e.g., replace, process, clean, etc. components of the manufacturing equipment 124). In some embodiments, the corrective action includes causing design optimization (e.g., updating manufacturing parameters, manufacturing processes, manufacturing equipment 124, etc. for an optimized product). In some embodiments, the corrective action includes a updating a recipe (e.g., altering the timing of manufacturing subsystems entering an idle or active mode, altering set points of various property values, etc.).

Predictive server 112, server machine 170, and server machine 180 may each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc. Operations of predictive server 112, server machine 170, server machine 180, data store 140, etc., may be performed by a cloud computing service, cloud data storage service, etc.

Predictive server 112 may include a predictive component 114. In some embodiments, the predictive component 114 may receive current metrology data 166 and generate output (e.g., predictive data 168) for performing corrective action associated with the manufacturing equipment 124 based on the current data. Receiving current metrology data 166 may include obtaining the data from client device 120. Receiving current metrology data 166 may include retrieving the data from data store 140. In some embodiments, predictive data 168 may include one or more predicted performance measurements of a processed product. In some embodiments, predictive data 168 may include a count, classification, density, and/or location map of epitaxial defects represented in image data of a substrate, predicted properties of epitaxial defects based on image data of the substrate, etc.

In some embodiments, predictive component 114 may determine epitaxial defects represented in image data (e.g., metrology data 160) based on image processing operations. For example, predictive component 114 may receive substrate image data. Predictive component 114 may perform pre-processing to improve usability of the image, such as gaussian blur operations, sharpening operations, etc. Predictive component 114 may perform transform operations (e.g., Fourier transform operations) to transform the image data from a spatial domain to a frequency domain. Predictive component 114 may apply filtering to the frequency domain image data. The filters may be designed to accentuate, highlight, or the like one or more target epitaxial defects. In some embodiments, an image of a substrate may have several filters applied, to generate a number of filtered image data for determining different types of epitaxial defects. Predictive component 114 may perform additional image processing techniques, such as transforming the image data back to a spatial domain, performing image thresholding, etc. Image thresholding may include increasing contrast of an image, e.g., to improve feature detection, defect detection, defect classification, etc. Image thresholding may include adjusting each pixel with brightness above a threshold value to maximum brightness (e.g., to a brightness of 1) and adjusting each pixel with brightness below the threshold value to a minimum brightness (e.g., to a brightness of 0). Predictive component 114 may perform feature detection operations such as contour detection, circle detection, or the like, to determine presence evidence of epitaxial defects in the image data.

In some embodiments, one or more operations of epitaxial film defect determination may be tuned to adjust/improve performance of the epitaxial film defect determination. In some embodiments, defect label data 162 may be provided for adjusting parameters of the epitaxial film defect determination. Defect label data 162 may include information indicative of defects of one or more substrates, one or more images, or the like, generated by a different method than the method the defect label data 162 is being used to tune. For example, defect label data 162 may be provided by a subject matter expert manually determining characteristics of defects of an epitaxial film. The defect label data 162 may be utilized in tuning parameters of an epitaxial film defect determination system to improve performance of the film defect determination system. Example parameters that may be adjusted include image pre-processing parameters, such as gaussian blur standard deviation, image filtering parameters, such as frequency domain filter shapes, image thresholding parameters, such as adjustment thresholds, and adjustment values, feature thresholds at which detected features are included in defect classification, etc.

In some embodiments, output of an epitaxial film defect determination process may be utilized for adjustment, calibration, and/or training of further processes. For example, if an epitaxial film defect determination process meets target performance thresholds (e.g., one or more target accuracy thresholds), output epitaxial film defect data may be utilized as defect label data 162 for adjusting parameters of other models. In some embodiments, defect characterization output by an epitaxial film defect determination system may be utilized as training input and/or target output for training a machine learning model.

Manufacturing equipment 124 may be associated with one or more machine leaning models, e.g., model 190. Machine learning models associated with manufacturing equipment 124 may perform many tasks, including process control, classification, performance predictions, etc. Model 190 may be trained using data associated with manufacturing equipment 124 or products processed by manufacturing equipment 124, e.g., sensor data 142 (e.g., collected by sensors 126), manufacturing parameters 150 (e.g., associated with process control of manufacturing equipment 124), metrology data 160 (e.g., generated by metrology equipment 128), etc.

In some embodiments, predictive system 110 may include a machine learning model for predicting unmeasured defect properties of a substrate. For example, imaging techniques may be performed that generate images of a subset of a surface of the substrate. A machine learning model (e.g., executed by predictive component 114) may be utilized to predict defect properties of unmeasured portions of the substrate, e.g., based on training data of other substrates with similar epitaxial film defect properties.

One type of machine learning model that may be used to perform some or all of the above tasks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g. classification outputs). CNNs have found particular applicability in the area of image processing, e.g., processing substrate image data for epitaxial defect determination.

A recurrent neural network (RNN) is another type of machine learning model. A recurrent neural network model is designed to interpret a series of inputs where inputs are intrinsically related to one another, e.g., time trace data, sequential data, etc. Output of a perceptron of an RNN is fed back into the perceptron as input, to generate the next output.

Deep learning is a class of machine learning algorithms that use a cascade of multiple layers of nonlinear processing units for feature extraction and transformation. Each successive layer uses the output from the previous layer as input. Deep neural networks may learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. In an image recognition application, for example, the raw input may be a matrix of pixels; the first representational layer may abstract the pixels and encode edges; the second layer may compose and encode arrangements of edges; the third layer may encode higher level shapes (e.g., teeth, lips, gums, etc.); and the fourth layer may recognize a scanning role. Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs may be that of the network and may be the number of hidden layers plus one. For recurrent neural networks, in which a signal may propagate through a layer more than once, the CAP depth is potentially unlimited.

In some embodiments, predictive component 114 receives current sensor data, current metrology data 166 and/or current manufacturing parameters, performs signal processing to break down the current data into sets of current data, provides the sets of current data as input to a trained model 190, and obtains outputs indicative of predictive data 168 from the trained model 190. In some embodiments, predictive component 114 receives metrology data (e.g., predicted metrology data based on sensor data) of a substrate and provides the metrology data to trained model 190. For example, current sensor data may include sensor data indicative of metrology (e.g., geometry) of a substrate. Model 190 may be configured to accept data indicative of substrate metrology and generate as output predicted properties of epitaxial defects of the substrate. In some embodiments, predictive data is indicative of metrology data (e.g., prediction of substrate quality). In some embodiments, predictive data is indicative of component health. In some embodiments, predictive data is indicative of processing progress (e.g., utilized to end a processing operation).

In some embodiments, the various models discussed in connection with model 190 (e.g., supervised machine learning model, unsupervised machine learning model, etc.) may be combined in one model (e.g., an ensemble model), or may be separate models.

Data may be passed back and forth between several distinct models included in model 190 and predictive component 114. In some embodiments, some or all of these operations may instead be performed by a different device, e.g., client device 120, server machine 170, server machine 180, etc. It will be understood by one of ordinary skill in the art that variations in data flow, which components perform which processes, which models are provided with which data, and the like are within the scope of this disclosure.

Data store 140 may be a memory (e.g., random access memory), a drive (e.g., a hard drive, a flash drive), a database system, a cloud-accessible memory system, or another type of component or device capable of storing data. Data store 140 may include multiple storage components (e.g., multiple drives or multiple databases) that may span multiple computing devices (e.g., multiple server computers). The data store 140 may store sensor data 142, manufacturing parameters 150, metrology data 160, synthetic data 162, and predictive data 168.

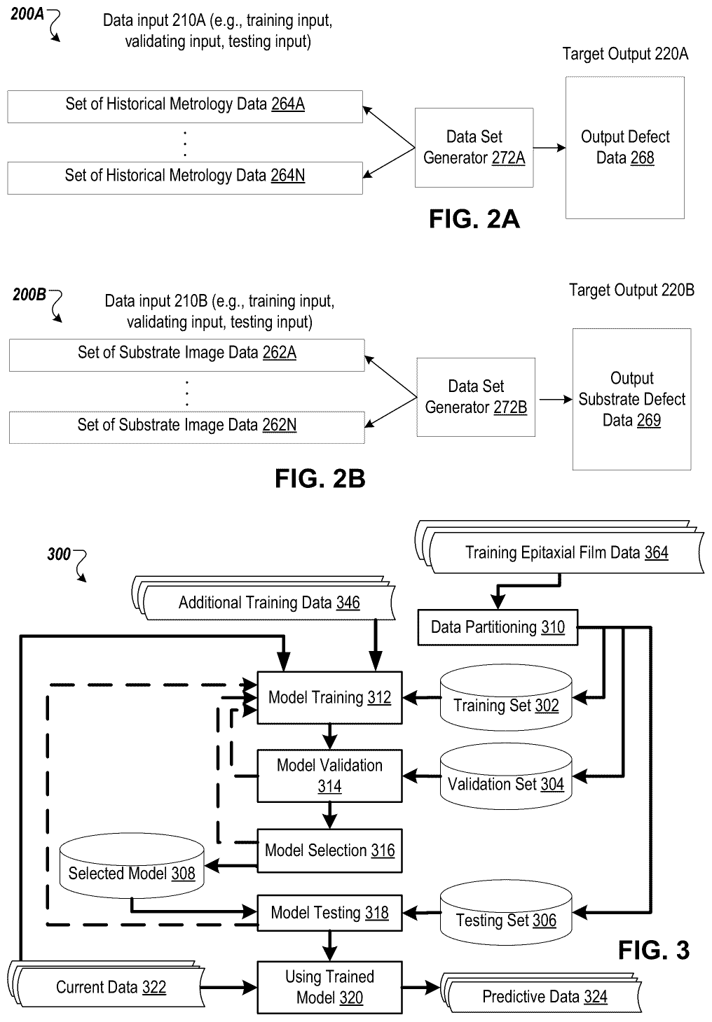

In some embodiments, predictive system 110 further includes server machine 170 and server machine 180. Server machine 170 includes a data set generator 172 that is capable of generating data sets (e.g., a set of data inputs and a set of target outputs) to train, validate, and/or test model(s) 190, including one or more machine learning models. Some operations of data set generator 172 are described in detail below with respect to FIGS. 2A-B and 4A. In some embodiments, data set generator 172 may partition the historical data (e.g., historical metrology data 164) into a training set (e.g., sixty percent of the historical data), a validating set (e.g., twenty percent of the historical data), and a testing set (e.g., twenty percent of the historical data).

In some embodiments, predictive system 110 (e.g., via predictive component 114) generates multiple sets of features. For example a first set of features may correspond to a first set of types of sensor data (e.g., from a first set of metrology equipment, first combination of values from first set of sensors, first type of substrate imaging technique, etc.) that correspond to each of the data sets (e.g., training set, validation set, and testing set) and a second set of features may correspond to a second set of types of sensor data (e.g., from a second set of sensors different from the first set of sensors, second combination of values different from the first combination, second patterns different from the first patterns) that correspond to each of the data sets.

Server machine 180 includes a training engine 182, a validation engine 184, selection engine 185, and/or a testing engine 186. An engine (e.g., training engine 182, a validation engine 184, selection engine 185, and a testing engine 186) may refer to hardware (e.g., circuitry, dedicated logic, programmable logic, microcode, processing device, etc.), software (such as instructions run on a processing device, a general purpose computer system, or a dedicated machine), firmware, microcode, or a combination thereof. The training engine 182 may be capable of training a model 190 using one or more sets of features associated with the training set from data set generator 172. The training engine 182 may generate multiple trained models 190, where each trained model 190 corresponds to a distinct set of features of the training set (e.g., sensor data from a distinct set of sensors). For example, a first trained model may have been trained using all features (e.g., X1-X5), a second trained model may have been trained using a first subset of the features (e.g., X1, X2, X4), and a third trained model may have been trained using a second subset of the features (e.g., X1, X3, X4, and X5) that may partially overlap the first subset of features. Data set generator 172 may receive the output of a trained model, collect that data into training, validation, and testing data sets, and use the data sets to train a second model (e.g., a machine learning model configured to output predictive data, corrective actions, etc.).

Validation engine 184 may be capable of validating a trained model 190 using a corresponding set of features of the validation set from data set generator 172. For example, a first trained machine learning model 190 that was trained using a first set of features of the training set may be validated using the first set of features of the validation set. The validation engine 184 may determine an accuracy of each of the trained models 190 based on the corresponding sets of features of the validation set. Validation engine 184 may discard trained models 190 that have an accuracy that does not meet a threshold accuracy. In some embodiments, selection engine 185 may be capable of selecting one or more trained models 190 that have an accuracy that meets a threshold accuracy. In some embodiments, selection engine 185 may be capable of selecting the trained model 190 that has the highest accuracy of the trained models 190.

Testing engine 186 may be capable of testing a trained model 190 using a corresponding set of features of a testing set from data set generator 172. For example, a first trained machine learning model 190 that was trained using a first set of features of the training set may be tested using the first set of features of the testing set. Testing engine 186 may determine a trained model 190 that has the highest accuracy of all of the trained models based on the testing sets.

In the case of a machine learning model, model 190 may refer to the model artifact that is created by training engine 182 using a training set that includes data inputs and corresponding target outputs (correct answers for respective training inputs. Patterns in the data sets can be found that map the data input to the target output (the correct answer), and machine learning model 190 is provided mappings that capture these patterns. The machine learning model 190 may use one or more of Support Vector Machine (SVM), Radial Basis Function (RBF), clustering, supervised machine learning, semi-supervised machine learning, unsupervised machine learning, k-Nearest Neighbor algorithm (k-NN), linear regression, random forest, neural network (e.g., artificial neural network, recurrent neural network), etc.

Predictive component 114 may provide current data to model 190 and may run model 190 on the input to obtain one or more outputs. For example, predictive component 114 may provide current sensor data 146 to model 190 and may run model 190 on the input to obtain one or more outputs. Predictive component 114 may be capable of determining (e.g., extracting) predictive data 168 from the output of model 190. Predictive component 114 may determine (e.g., extract) confidence data from the output that indicates a level of confidence that predictive data 168 is an accurate predictor of a process associated with the input data for products produced or to be produced using the manufacturing equipment 124 at the current sensor data 146 and/or current manufacturing parameters. Predictive component 114 or corrective action component 122 may use the confidence data to decide whether to cause a corrective action associated with the manufacturing equipment 124 based on predictive data 168.

The confidence data may include or indicate a level of confidence that the predictive data 168 is an accurate prediction for products or components associated with at least a portion of the input data. In one example, the level of confidence is a real number between 0 and 1 inclusive, where 0 indicates no confidence that the predictive data 168 is an accurate prediction for products processed according to input data or component health of components of manufacturing equipment 124 and 1 indicates absolute confidence that the predictive data 168 accurately predicts properties of products processed according to input data or component health of components of manufacturing equipment 124. Responsive to the confidence data indicating a level of confidence below a threshold level for a predetermined number of instances (e.g., percentage of instances, frequency of instances, total number of instances, etc.) predictive component 114 may cause trained model 190 to be re-trained (e.g., based on current sensor data 146, current manufacturing parameters, etc.). In some embodiments, retraining may include generating one or more data sets (e.g., via data set generator 172) utilizing historical data.

For purpose of illustration, rather than limitation, aspects of the disclosure describe the training of one or more machine learning models 190 using historical data (e.g., historical sensor data, historical manufacturing parameters) and inputting current data (e.g., current sensor data, current manufacturing parameters, and current metrology data) into the one or more trained machine learning models to determine predictive data 168. In other embodiments, a heuristic model, physics-based model, or rule-based model is used to determine predictive data 168 (e.g., without using a trained machine learning model). In some embodiments, such models may be trained using historical data. Predictive component 114 may monitor historical sensor data 144, historical manufacturing parameters, and metrology data 160. Any of the information described with respect to data inputs 210A-B of FIGS. 2A-B may be monitored or otherwise used in the heuristic, physics-based, or rule-based model.

In some embodiments, the functions of client device 120, predictive server 112, server machine 170, and server machine 180 may be provided by a fewer number of machines. For example, in some embodiments server machines 170 and 180 may be integrated into a single machine, while in some other embodiments, server machine 170, server machine 180, and predictive server 112 may be integrated into a single machine. In some embodiments, client device 120 and predictive server 112 may be integrated into a single machine. In some embodiments, functions of client device 120, predictive server 112, server machine 170, server machine 180, and data store 140 may be performed by a cloud-based service.

In general, functions described in one embodiment as being performed by client device 120, predictive server 112, server machine 170, and server machine 180 can also be performed on predictive server 112 in other embodiments, if appropriate. In addition, the functionality attributed to a particular component can be performed by different or multiple components operating together. For example, in some embodiments, the predictive server 112 may determine the corrective action based on the predictive data 168. In another example, client device 120 may determine the predictive data 168 based on output from the trained machine learning model.

In addition, the functions of a particular component can be performed by different or multiple components operating together. One or more of the predictive server 112, server machine 170, or server machine 180 may be accessed as a service provided to other systems or devices through appropriate application programming interfaces (API).

In embodiments, a “user” may be represented as a single individual. However, other embodiments of the disclosure encompass a “user” being an entity controlled by a plurality of users and/or an automated source. For example, a set of individual users federated as a group of administrators may be considered a “user.”

FIGS. 2A-B depict block diagrams of example data set generators 272A-B (e.g., data set generator 172 of FIG. 1) to create data sets for training, testing, validating, etc. a model (e.g., model 190 of FIG. 1), according to some embodiments. Each data set generator 272 may be part of server machine 170 of FIG. 1. In some embodiments, several machine learning models associated with manufacturing equipment 124 may be trained, used, and maintained (e.g., within a manufacturing facility). Each model may be associated with one data set generators 272, multiple models may share a data set generator 272, etc.

FIG. 2A depicts a system 200A including data set generator 272A for creating data sets for one or more supervised models (e.g., model 190 of FIG. 1). Data set generator 272A may create data sets (e.g., data input 210A, target output 220A) using historical data. In some embodiments, a data set generator similar to data set generator 272A may be utilized to train an unsupervised machine learning model, e.g., target output 220A may not be generated by data set generator 272A.

Data set generator 272A may generate data sets to train, test, and validate a model. In some embodiments, data set generator 272A may generate data sets for a machine learning model. In some embodiments, data set generator 272A may generate data sets for training, testing, and/or validating a model configured to generate characterizations of epitaxial defects of a substrate. The machine learning model is provided with set of historical metrology data 264A as data input 210A. The machine learning model may be configured to accept metrology data as input data and generate characterization of epitaxial film defects as output.

Data set generator 272A may be used to generate data for any type of machine learning model that takes as input metrology data. Data set generator 272A may be used to generate data for a machine learning model that generates predicted metrology data of a substrate. Data set generator 272A may be used to generate data for a machine learning model configured to provide substrate screening. Data set generator 272A may be used to generate data for a machine learning model configured to identify a product anomaly and/or processing equipment fault. Data set generator 272A may be used to generate data for a machine learning model configured to predict epitaxial defect properties of a substrate.

In some embodiments, data set generator 272A generates a data set (e.g., training set, validating set, testing set) that includes one or more data inputs 210A (e.g., training input, validating input, testing input). Data inputs 210A may be provided to training engine 182, validating engine 184, or testing engine 186. The data set may be used to train, validate, or test the model.

In some embodiments, data input 210A may include one or more sets of data. As an example, system 200A may produce sets of data that may include one or more of metrology data from one or more types of metrology equipment, combinations of data from one or more types of metrology equipment, metrology data from one or more locations of associated substrates, patterns from metrology data from one or more types of imaging, etc.

In some embodiments, data input 210A may include one or more sets of data. As an example, system 200A may produce sets of historical metrology data that may include one or more of metrology data of a group of dimensions of a device (e.g., include height and width of the device but not optical data or surface roughness, etc.), metrology data derived from one or more types of sensors, combination of metrology data derived from one or more types of sensors, patterns from metrology data, metrology data preprocessed in different ways, metrology data generated by different equipment and/or techniques, etc. Sets of data input 210A may include data describing different aspects of manufacturing, e.g., a combination of metrology data and sensor data, a combination of metrology data and manufacturing parameters, combinations of some metrology data, some manufacturing parameter data and some sensor data, etc.

In some embodiments, data set generator 272A may generate a first data input corresponding to a first set of historical metrology data 264A to train, validate, or test a first machine learning model. Data set generator 272A may generate a second data input corresponding to a second set of historical metrology data (e.g., a set of historical metrology data 264B, not shown) to train, validate, or test a second machine learning model. Further sets of historical metrology data may further be utilized in generating further machine learning models. Any number of sets of historical metrology data may be utilized in generating any number of machine learning models, up to a final set, set of historical metrology data 264N (N representing any target quantity of data sets, models, etc.).

In some embodiments, data set generator 272A generates a data set (e.g., training set, validating set, testing set) that includes one or more data inputs 210A (e.g., training input, validating input, testing input) and may include one or more target outputs 220A that correspond to the data inputs 210A. The data set may also include mapping data that maps the data inputs 210A to the target outputs 220A. In some embodiments, data set generator 272A may generate data for training a machine learning model configured to output characterizations of epitaxial defects included in the input image data, e.g., as output defect data 268. In some embodiments, output defect data 268 may be generated by another system for determining epitaxial defects of a substrate, e.g., target output 220A may be output by another model, algorithm, predictive system, etc. Output defect data 268 may be generated by predictive system 110 of FIG. 1. Data inputs 210A may also be referred to as “features,” “attributes,” or “information.” In some embodiments, data set generator 272A may provide the data set to training engine 182, validating engine 184, or testing engine 186, where the data set is used to train, validate, or test the machine learning model (e.g., synthetic data generator 174, one of the machine learning models that are included in model 190, ensemble model 190, etc.).

FIG. 2B depicts a block diagram of an example data set generator 272B for creating data sets for a supervised model configured to generate an indication of predicted epitaxial defect properties of a substrate, according to some embodiments. System 200B containing data set generator 272B (e.g., data set generator 172 of FIG. 1) creates data sets for one or more machine learning models (e.g., model 190 of FIG. 1). Data set generator 272B may create data sets (e.g., data input 210B) using historical data.

Example data set generator 272B is configured to generate data sets for a machine learning model configured to take as input image data of a portion of a substrate and generate as output predictive defect data of a second portion of the substrate, e.g., an entire surface of the substrate. Analogous data set generators (or analogous operations of data set generator 272B) may be utilized for machine learning models configured to perform different functions, e.g., a machine learning model configured to receive as input metrology image data and generate as output predicted root causes of epitaxial defects, a machine learning model configured to receive as input image data of a substrate and generate as output recommended corrective actions, etc. Data set generator 272B may share features and/or function with data set generator 272A.

Data set generator 272B may generate data sets to train, test, and validate a machine learning model. The machine learning model is provided with set of substate image data 262A (e.g., image data of one or more portions of a substrate, location data associated with the image data identifying associated substrate locations, etc.) as data input 210B. The machine learning model may include two or more separate models (e.g., the machine learning model may be an ensemble model). The machine learning model may be configured to generate output data including predicted substrate defect data (e.g., in portions of the substrate not included in the image data provided as input. In some embodiments, training may not include providing target output to the machine learning model. Data set generator 272B may generate data sets to train an unsupervised machine learning model, e.g., a model configured to generate as output clustering data, outlier detection data, anomaly detection data, etc. Data set generator 272B may generate accompanying target output 220B for the data input 210B. Target output 220B may include output substrate defect data 269, e.g., output indicative of defects in portions of the substrate not included in the input data, for configuring a machine learning model to predict epitaxial defect properties (e.g., defect classification, count, density, location, etc.) in portions of the substrate that are not associated with image data provided as input to the machine learning model.

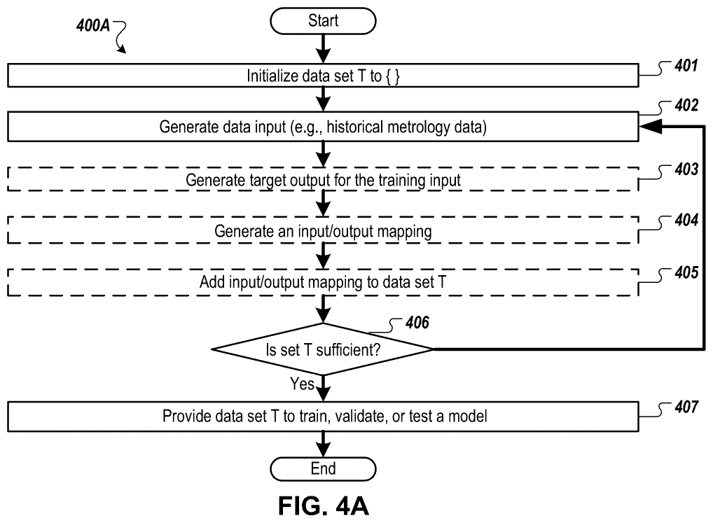

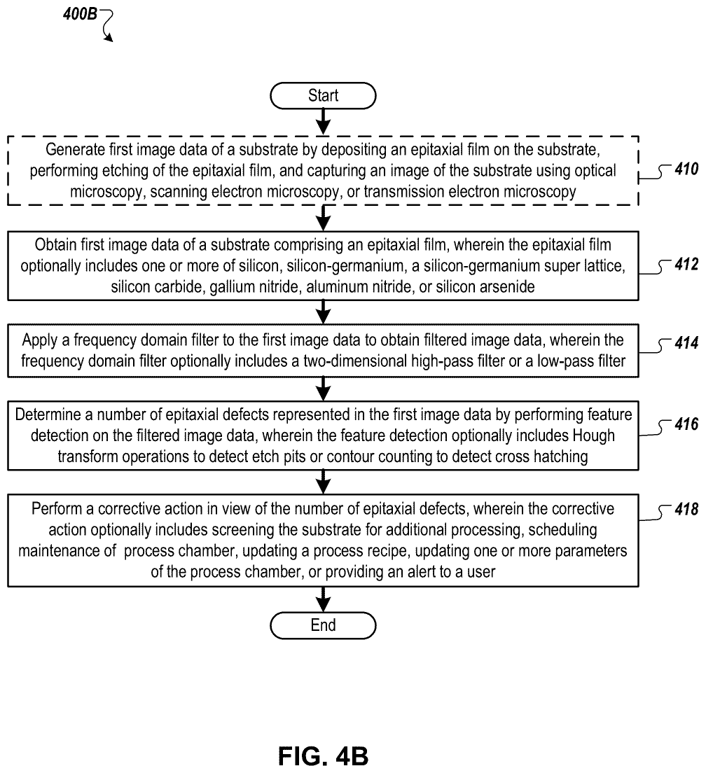

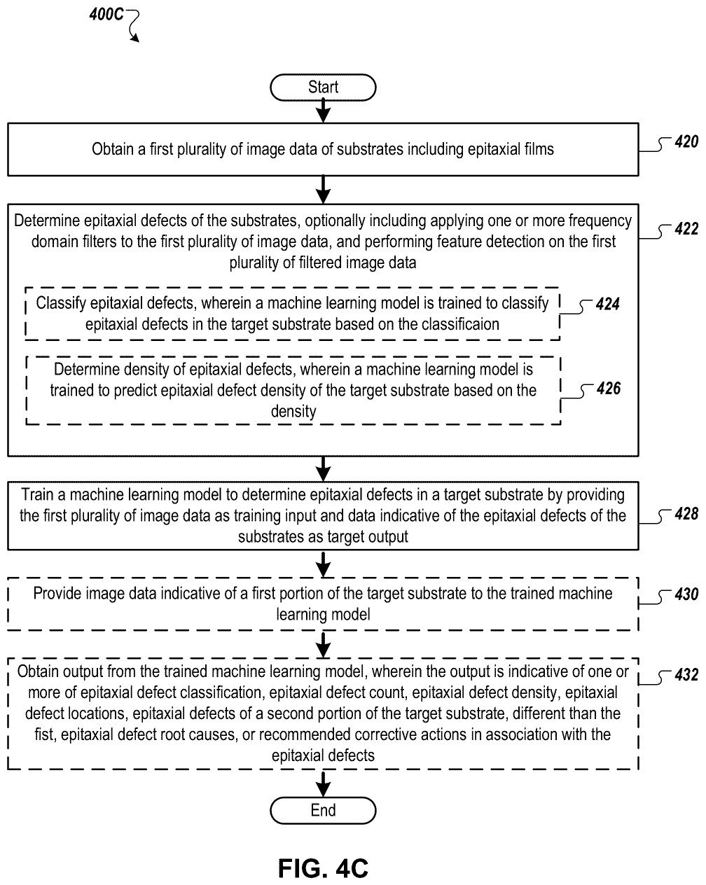

In some embodiments, data set generator 272B generates a data set (e.g., training set, validating set, testing set) that includes one or more data inputs 210B (e.g., training input, validating input, testing input). Data inputs 210B may also be referred to as “features,” “attributes,” or “information.” In some embodiments, data set generator 272B may provide the data set to the training engine 182, validating engine 184, or testing engine 186, where the data set is used to train, validate, or test the machine learning model (e.g., model 190 of FIG. 1). Some embodiments of generating a training set are further described with respect to FIG. 4A.

In some embodiments, data set generator 272B may generate a first data input corresponding to a first set of substrate image data 262A to train, validate, or test a first machine learning model and the data set generator 272A may generate a second data input corresponding to a second set of data (e.g., a set of substrate image data 262B, not shown) to train, validate, or test a second machine learning model. Further sets of substrate image data may further be utilized in generating further machine learning models. Any number of sets of substrate image data may be utilized in generating any number of machine learning models, up to a final set, set of substrate image data 262N (N representing any target quantity of data sets, models, etc.).

Data inputs 210B to train, validate, or test a machine learning model may include information for a particular manufacturing chamber (e.g., for particular substrate manufacturing equipment). In some embodiments, data inputs 210B may include information for a specific type of manufacturing equipment, e.g., manufacturing equipment sharing specific characteristics. Data inputs 210B may include data associated with a device of a certain type, e.g., intended function, design, produced with a particular recipe, etc. Training a machine learning model based on a type of equipment, device, recipe, etc. may allow the trained model to generate plausible synthetic sensor data in a number of settings (e.g., for a number of different facilities, products, etc.).

In some embodiments, subsequent to generating a data set and training, validating, or testing a machine learning model using the data set, the model may be further trained, validated, or tested, or adjusted (e.g., adjusting weights or parameters associated with input data of the model, such as connection weights in a neural network).

FIG. 3 is a block diagram illustrating system 300 for generating output data (e.g., predictive data 168 of FIG. 1), according to some embodiments. In some embodiments, system 300 may be used in conjunction with a machine learning model configured to generate predictions of epitaxial film defects (e.g., model 190 of FIG. 1). In some embodiments, system 300 may be used in conjunction with a machine learning model to determine a corrective action associated with manufacturing equipment. In some embodiments, system 300 may be used in conjunction with a machine learning model to determine a fault of manufacturing equipment. In some embodiments, system 300 may be used in conjunction with a machine learning model to predict epitaxial film defect properties of substrates. System 300 may be used in conjunction with a machine learning model with a different function than those listed, associated with a manufacturing system.

At block 310, system 300 (e.g., components of predictive system 110 of FIG. 1) performs data partitioning (e.g., via data set generator 172 of server machine 170 of FIG. 1) of data to be used in training, validating, and/or testing a machine learning model. In some embodiments, training epitaxial film data 364 includes historical data, such as historical metrology data, historical classification data (e.g., classification of epitaxial defects associated with the same substrates as are represented by the metrology data), historical microscopy image data, etc. In some embodiments, classification data may be provided by an epitaxial film defect system, e.g., predictive system 110 of FIG. 1. Training epitaxial film data 364 may undergo data partitioning at block 310 to generate training set 302, validation set 304, and testing set 306. For example, the training set may be 60% of the training data, the validation set may be 20% of the training data, and the testing set may be 20% of the training data.

The generation of training set 302, validation set 304, and testing set 306 may be tailored for a particular application. For example, the training set may be 60% of the training data, the validation set may be 20% of the training data, and the testing set may be 20% of the training data. System 300 may generate a plurality of sets of features for each of the training set, the validation set, and the testing set. For example, if training epitaxial film data 364 includes sensor data, including features derived from sensor data from 20 sensors (e.g., sensors 126 of FIG. 1) and 10 manufacturing parameters (e.g., manufacturing parameters that correspond to the same processing runs(s) as the sensor data from the 20 sensors), the sensor data may be divided into a first set of features including sensors 1-10 and a second set of features including sensors 11-20. The manufacturing parameters may also be divided into sets, for instance a first set of manufacturing parameters including parameters 1-5, and a second set of manufacturing parameters including parameters 6-10. Either target input, target output, both, or neither may be divided into sets. Multiple models may be trained on different sets of data.

At block 312, system 300 performs model training (e.g., via training engine 182 of FIG. 1) using training set 302. Training of a machine learning model and/or of a physics-based model (e.g., a digital twin) may be achieved in a supervised learning manner, which involves providing a training dataset including labeled inputs through the model, observing its outputs, defining an error (by measuring the difference between the outputs and the label values), and using techniques such as deep gradient descent and backpropagation to tune the weights of the model such that the error is minimized. In many applications, repeating this process across the many labeled inputs in the training dataset yields a model that can produce correct output when presented with inputs that are different than the ones present in the training dataset. In some embodiments, training of a machine learning model may be achieved in an unsupervised manner, e.g., labels or classifications may not be supplied during training. An unsupervised model may be configured to perform anomaly detection, result clustering, etc.

For each training data item in the training dataset, the training data item may be input into the model (e.g., into the machine learning model). The model may then process the input training data item (e.g., an image of a substrate etc.) to generate an output. The output may include, for example, characterization of epitaxial defects of the substrate. The output may be compared to a label of the training data item (e.g., epitaxial film defect data classified by another reliable method).

Processing logic may then compare the generated output (e.g., predicted epitaxial defect data) to the label (e.g., labeled epitaxial defect data) that was included in the training data item. Processing logic determines an error (i.e., a classification error) based on the differences between the output and the label(s). Processing logic adjusts one or more weights and/or values of the model based on the error.

In the case of training a neural network, an error term or delta may be determined for each node in the artificial neural network. Based on this error, the artificial neural network adjusts one or more of its parameters for one or more of its nodes (the weights for one or more inputs of a node). Parameters may be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters may include adjusting the weights assigned to each of the inputs for one or more neurons at one or more layers in the artificial neural network.

System 300 may train multiple models using multiple sets of features of the training set 302 (e.g., a first set of features of the training set 302, a second set of features of the training set 302, etc.). For example, system 300 may train a model to generate a first trained model using the first set of features in the training set (e.g., sensor data from sensors 1-10, metrology measurements 1-10, etc.) and to generate a second trained model using the second set of features in the training set (e.g., sensor data from sensors 11-20, metrology measurements 11-20, etc.). In some embodiments, the first trained model and the second trained model may be combined to generate a third trained model (e.g., which may be a better predictor than the first or the second trained model on its own). In some embodiments, sets of features used in comparing models may overlap (e.g., first set of features being sensor data from sensors 1-15 and second set of features being sensors 5-20). In some embodiments, hundreds of models may be generated including models with various permutations of features and combinations of models.

At block 314, system 300 performs model validation (e.g., via validation engine 184 of FIG. 1) using the validation set 304. The system 300 may validate each of the trained models using a corresponding set of features of the validation set 304. For example, system 300 may validate the first trained model using the first set of features in the validation set (e.g., sensor data from sensors 1-10 or metrology measurements 1-10) and the second trained model using the second set of features in the validation set (e.g., sensor data from sensors 11-20 or metrology measurements 11-20). In some embodiments, system 300 may validate hundreds of models (e.g., models with various permutations of features, combinations of models, etc.) generated at block 312. At block 314, system 300 may determine an accuracy of each of the one or more trained models (e.g., via model validation) and may determine whether one or more of the trained models has an accuracy that meets a threshold accuracy. Responsive to determining that none of the trained models has an accuracy that meets a threshold accuracy, flow returns to block 312 where the system 300 performs model training using different sets of features of the training set. Responsive to determining that one or more of the trained models has an accuracy that meets a threshold accuracy, flow continues to block 316. System 300 may discard the trained models that have an accuracy that is below the threshold accuracy (e.g., based on the validation set).

At block 316, system 300 performs model selection (e.g., via selection engine 185 of FIG. 1) to determine which of the one or more trained models that meet the threshold accuracy has the highest accuracy (e.g., the selected model 308, based on the validating of block 314). Responsive to determining that two or more of the trained models that meet the threshold accuracy have the same accuracy, flow may return to block 312 where the system 300 performs model training using further refined training sets corresponding to further refined sets of features for determining a trained model that has the highest accuracy.

At block 318, system 300 performs model testing (e.g., via testing engine 186 of FIG. 1) using testing set 306 to test selected model 308. System 300 may test, using the first set of features in the testing set (e.g., sensor data from sensors 1-10), the first trained model to determine the first trained model meets a threshold accuracy. Determining whether the first trained model meets a threshold accuracy may be based on the first set of features of testing set 306. Responsive to accuracy of the selected model 308 not meeting the threshold accuracy, flow continues to block 312 where system 300 performs model training (e.g., retraining) using different training sets corresponding to different sets of features. Accuracy of selected model 308 may not meet threshold accuracy if selected model 308 is overly fit to the training set 302 and/or validation set 304. Accuracy of selected model 308 may not meet threshold accuracy if selected model 308 is not applicable to other data sets, including testing set 306. Training using different features may include training using data from different sensors, different manufacturing parameters, etc. Responsive to determining that selected model 308 has an accuracy that meets a threshold accuracy based on testing set 306, flow continues to block 320. In at least block 312, the model may learn patterns in the training data to make predictions. In block 318, the system 300 may apply the model on the remaining data (e.g., testing set 306) to test the predictions.

At block 320, system 300 uses the trained model (e.g., selected model 308) to receive current data 322 and determines (e.g., extracts), from the output of the trained model, predictive data 324. Current data 322 may be image data related to a process, operation, substrate, or action of interest. Current data 322 may be image data of at least a portion of a substrate of interest. Current data 322 may be metrology data of a substrate of interest. Current data 322 may be manufacturing parameters related to a process under development, redevelopment, investigation, etc. A corrective action associated with the manufacturing equipment 124 of FIG. 1 may be performed in view of predictive data 324. In some embodiments, current data 322 may correspond to the same types of features in the historical data used to train the machine learning model. In some embodiments, current data 322 corresponds to a subset of the types of features in historical data that are used to train selected model 308. For example, a machine learning model may be trained using a number of manufacturing parameters, and configured to generate output based on a subset of the manufacturing parameters.

In some embodiments, the performance of a machine learning model trained, validated, and tested by system 300 may deteriorate. For example, a manufacturing system associated with the trained machine learning model may undergo a gradual change or a sudden change. A change in the manufacturing system may result in decreased performance of the trained machine learning model. A new model may be generated to replace the machine learning model with decreased performance. The new model may be generated by altering the old model by retraining, by generating a new model, etc.

Generation of a new model may include providing additional training data 346. Generation of a new model may further include providing current data 322, e.g., data that has been used by the model to make predictions. In some embodiments, current data 322 when provided for generation of a new model may be labeled with an indication of an accuracy of predictions generated by the model based on current data 322. Additional training data 346 may be provided to model training at block 312 for generation of one or more new machine learning models, updating, retraining, and/or refining of selected model 308, etc.

In some embodiments, one or more of the acts 310-320 may occur in various orders and/or with other acts not presented and described herein. In some embodiments, one or more of acts 310-320 may not be performed. For example, in some embodiments, one or more of data partitioning of block 310, model validation of block 314, model selection of block 316, or model testing of block 318 may not be performed.

FIG. 3 depicts a system configured for training, validating, testing, and using one or more machine learning models. The machine learning models are configured to accept data as input (e.g., set points provided to manufacturing equipment, sensor data, metrology data, etc.) and provide data as output (e.g., predictive data, corrective action data, classification data, etc.). Partitioning, training, validating, selection, testing, and using blocks of system 300 may be executed similarly to train a second model, utilizing different types of data. Retraining may also be performed, utilizing current data 322 and/or additional training data 346.

FIGS. 4A-C are flow diagrams of methods 400A-C. FIGS. 4A-C are associated with performing determinations of epitaxial film defects of substrates, including defect classification, defect counting, defect predictions, corrective action recommendations based on epitaxial film defects, etc. One or more of FIGS. 4A-C may be associated with training and utilizing machine learning models, according to certain embodiments. Methods 400A-C may be performed by processing logic that may include hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiment, methods 400A-C may be performed, in part, by predictive system 110. Method 400A may be performed, in part, by predictive system 110 (e.g., server machine 170 and data set generator 172 of FIG. 1, data set generators 272A-B of FIGS. 2A-B). Predictive system 110 may use method 400A to generate a data set to at least one of train, validate, or test a machine learning model, in accordance with embodiments of the disclosure. Methods 400B-C may be performed by predictive server 112 (e.g., predictive component 114) and/or server machine 180 (e.g., training, validating, and testing operations may be performed by server machine 180). In some embodiments, a non-transitory machine-readable storage medium stores instructions that when executed by a processing device (e.g., of predictive system 110, of server machine 180, of predictive server 112, etc.) cause the processing device to perform one or more of methods 400A-C.

For simplicity of explanation, methods 400A-C are depicted and described as a series of operations. However, operations in accordance with this disclosure can occur in various orders and/or concurrently and with other operations not presented and described herein. Furthermore, not all illustrated operations may be performed to implement methods 400A-C in accordance with the disclosed subject matter. In addition, those skilled in the art will understand and appreciate that methods 400A-C could alternatively be represented as a series of interrelated states via a state diagram or events.

FIG. 4A is a flow diagram of a method 400A for generating a data set for a machine learning model, according to some embodiments. Referring to FIG. 4A, in some embodiments, at block 401 the processing logic implementing method 400A initializes a training set T to an empty set.

At block 402, processing logic generates first data input (e.g., first training input, first validating input) that may include one or more of sensor, manufacturing parameters, metrology data, etc. In some embodiments, the first data input may include a first set of features for types of data and a second data input may include a second set of features for types of data (e.g., as described with respect to FIG. 3). In some embodiments, the data input includes historical metrology data. In some embodiments, the data input includes historical image data, including indications of epitaxial film defects.

In some embodiments, at block 403, processing logic optionally generates a first target output for one or more of the data inputs (e.g., first data input). In some embodiments, the input includes one or more metrology measurements and the target output is one or more characteristics of epitaxial defects related to the metrology measurements. In some embodiments, the first target output of the machine learning model is predictive data. In some embodiments, input data may be in the form of data indicative of epitaxial defects, and target output may be a list of components likely to be faulty, as in the case of a machine learning model configured to identify failing manufacturing systems. In some embodiments, no target output is generated (e.g., an unsupervised machine learning model capable of grouping or finding correlations in input data, rather than requiring target output to be provided).

At block 404, processing logic optionally generates mapping data that is indicative of an input/output mapping. The input/output mapping (or mapping data) may refer to the data input (e.g., one or more of the data inputs described herein), the target output for the data input, and an association between the data input(s) and the target output. In some embodiments, such as in association with machine learning models where no target output is provided, block 404 may not be executed.

At block 405, processing logic adds the mapping data generated at block 404 to data set T, in some embodiments.

At block 406, processing logic branches based on whether data set T is sufficient for at least one of training, validating, and/or testing a machine learning model, such as synthetic data generator 174 or model 190 of FIG. 1. If so, execution proceeds to block 407, otherwise, execution continues back at block 402. It should be noted that in some embodiments, the sufficiency of data set T may be determined based simply on the number of inputs, mapped in some embodiments to outputs, in the data set, while in some other embodiments, the sufficiency of data set T may be determined based on one or more other criteria (e.g., a measure of diversity of the data examples, accuracy, etc.) in addition to, or instead of, the number of inputs.

At block 407, processing logic provides data set T (e.g., to server machine 180) to train, validate, and/or test machine learning model 190. In some embodiments, data set T is a training set and is provided to training engine 182 of server machine 180 to perform the training. In some embodiments, data set T is a validation set and is provided to validation engine 184 of server machine 180 to perform the validating. In some embodiments, data set T is a testing set and is provided to testing engine 186 of server machine 180 to perform the testing. In the case of a neural network, for example, input values of a given input/output mapping (e.g., numerical values associated with data inputs 210A) are input to the neural network, and output values (e.g., numerical values associated with target outputs 220A) of the input/output mapping are stored in the output nodes of the neural network. The connection weights in the neural network are then adjusted in accordance with a learning algorithm (e.g., back propagation, etc.), and the procedure is repeated for the other input/output mappings in data set T. After block 407, a model (e.g., model 190) can be at least one of trained using training engine 182 of server machine 180, validated using validating engine 184 of server machine 180, or tested using testing engine 186 of server machine 180. The trained model may be implemented by predictive component 114 (of predictive server 112) to generate predictive data 168 for performing signal processing, or for performing a corrective action associated with manufacturing equipment 124.

FIG. 4B is a flow diagram of a method 400B for performing a corrective action in view of epitaxial film defect determination, according to some embodiments. At block 410, processing logic optionally generates first image data of a substrate. Generating first image data of the substrate may include causing deposition of an epitaxial film on the substrate. Generating first image data of the substrate may include performing etching of the epitaxial film, e.g., decorating epitaxial defects by plasma etching, chemical etching, etc. Decorating epitaxial defects may cause the epitaxial defects to appear more clearly in images of the substrate, e.g., microscopy images. Generating the first image data may include capturing one or more images of the substrate utilizing optical microscopy, scanning electron microscopy, or transmission electron microscopy.

At block 412, processing logic obtains first image data of the substrate including the epitaxial film. The epitaxial film may be a film deposited on a semiconductor substrate. The epitaxial film may be a film deposited on a silicon substrate. The epitaxial film may include one or more defects. The epitaxial film may include etch pit defects, cross-hatch defects, etc. The epitaxial film may include a single layer (e.g., a single epitaxial layer) or multiple layers. The epitaxial film may be doped. The epitaxial film may not be doped. The epitaxial film may include silicon (e.g., n-type doped silicon, p-type doped silicon), silicon-germanium, silicon-carbide, gallium nitride, aluminum nitride, gallium arsenide, gallium aluminum nitride, or silicon arsenide. The epitaxial film may include carbon, boron, arsenic, antimony, tin, indium, phosphorus, etc. The epitaxial film may include a silicon/silicon-germanium super lattice.

At block 414, processing logic applies a frequency domain filter to the first image data to obtain filtered image data. The frequency domain filter may be designed to highlight one or more types of epitaxial defects in the image data. Multiple frequency domain filters may be applied (e.g., to different copies of the first image data) to determine different classes of epitaxial defects. Frequency filters may include two-dimensional high-pass filters. Frequency filters may include low-pass filters. Frequency filters may be tuned to improve epitaxial defect determinations of the processing device.

Further processing may be performed of the image data. For example, various image processing techniques to improve feature detection may be performed on the image data, such as sharpening, smoothing, gaussian blur, artifact removal, or the like. The image data may be provided as spatial domain data, and may be transformed into frequency domain data (e.g., via a Fourier transform, fast Fourier transform, etc.). The filtered image data may be transformed back to a spatial domain. Image thresholding may be performed to generate high contrast images, e.g., by adjusting all pixels of the image above a threshold brightness to maximum brightness, and adjusting all pixels of the image below the threshold brightness to minimum brightness.

At block 416, processing logic determines a number of epitaxial defects represented in the first image by performing feature detection on the filtered image data. Feature detection may be utilized to determine portions of the image data that are indicative of epitaxial defects. Feature detection may include a Hough transform. A Hough transformation is used to identify shapes or patterns in an image by transforming the image's pixel data into a different representation, know as the Hough space, where a target shape in the original image is represented by a set of parameters in the Hough space. An accumulator is utilized to find points with relationships to each other that correspond to the target shape. Hough transform may be utilized in detecting circles in the image data, which may be used to determine the presence of etch pits in the epitaxial film. Feature detection may include contour counting. Contour counting may include utilizing techniques such as canny edge detection to find connected regions of pixels in an image that satisfy threshold similarity conditions, such as brightness similarity, color similarity, or the like. Contour counting may be utilized to determine locations and number of cross hatchings in image data of an epitaxial film.

At block 418, processing logic performs a corrective action in view of the number of epitaxial defects. The corrective action may include screening the substrate for additional processing. The corrective action may include screening the substrate for performance of additional process operations. The corrective action may include scheduling maintenance of a processing chamber associated with (e.g., used to deposit the epitaxial film of) the substrate. The corrective action may include performing maintenance or initiating performance of maintenance of the processing chamber. The corrective action may include updating a process recipe. The corrective action may include updating one or more parameters of the process chamber (e.g., manufacturing parameters of the process chamber). The corrective action may include providing an alert to a user.

FIG. 4C is a flow diagram of a method 400C for training and utilizing a machine learning model in connection with epitaxial defect determination of a target substrate, according to some embodiments. At block 420, processing logic obtains a first plurality of image data of substrates that include epitaxial films. The image data may include images of the substrates collected with metrology equipment, e.g., microscopy data, scanning electron microscopy data, transmission electron microscopy data, etc.

At block 422, processing logic determines epitaxial defects of the substrates. Determining epitaxial defects of the substrates may include applying one or more operations described in connection with FIG. 4B. For example, determining epitaxial defects may include transforming image data to a frequency domain, applying one or more frequency domain filters, performing feature detection on filtered frequency domain data, etc.

Block 424 is optionally included in operations of determining epitaxial defects. Determining epitaxial defects may include classifying epitaxial defects. Classifying epitaxial defects may include labeling defects as etch pits or cross hatch defects. Classification of epitaxial defects may be performed as part of operations for training a machine learning model for epitaxial defect classification.

Block 426 is optionally included in operations of determining epitaxial defects. Determining epitaxial defects may include determining a density of epitaxial defects. Determining a density of epitaxial defects may be performed as part of operations for training a machine learning model for epitaxial defect density prediction. Further operations related to epitaxial defects may be performed, e.g., for later use in training a machine learning model for a target function. Operations may include locating epitaxial defects, determining root causes of epitaxial defects, determining corrective actions in view of epitaxial defects, etc.

At block 428, processing logic trains a machine learning model to determine epitaxial defects in a target substrate. Training the machine learning model includes providing the first plurality of image data as training input. Training the machine learning model includes providing data indicative of the epitaxial defects of the substrates as target output. In some embodiments, such as for training a machine learning model for predicting defect density of portions of a substrate that are not imaged, the training input may include image data of a first portion of one or more substrates and the target output data may include image data of a second portion of the one or more substrates, different than the first.

At blocks 430 and 432, processing logic optionally performs inference operations of the trained machine learning model. At block 430, processing logic optionally provides image data indicative of a first portion of the target substrate to the trained machine learning model.

At block 432, processing logic obtains output from the trained machine learning model. The output is indicative of one or more of epitaxial defect classification, epitaxial defect count, epitaxial defect density, epitaxial defect locations, epitaxial defects of a second portion of the target substrate, epitaxial defect root causes, or recommended corrective actions in association with the epitaxial defects.

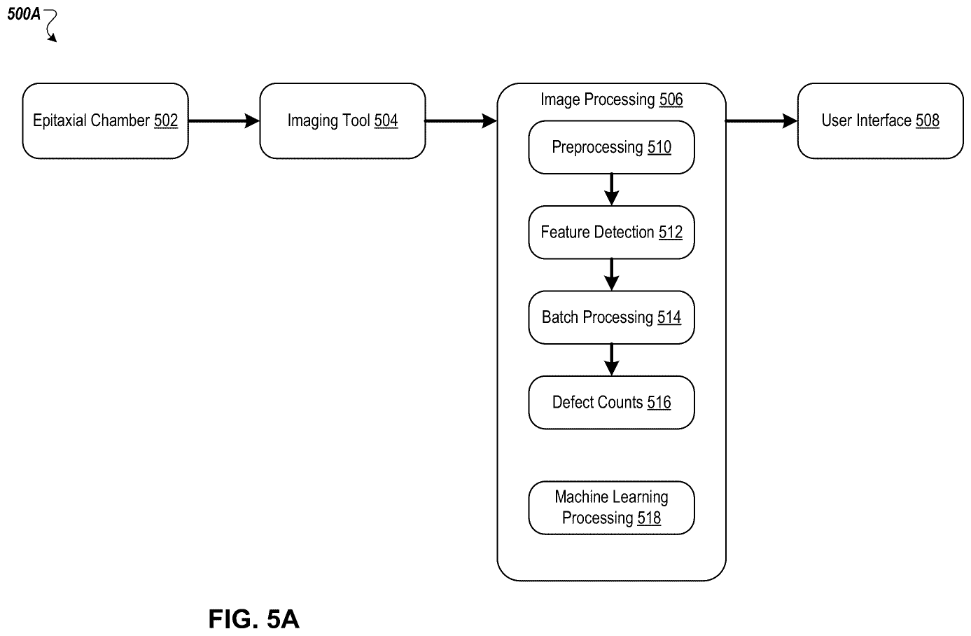

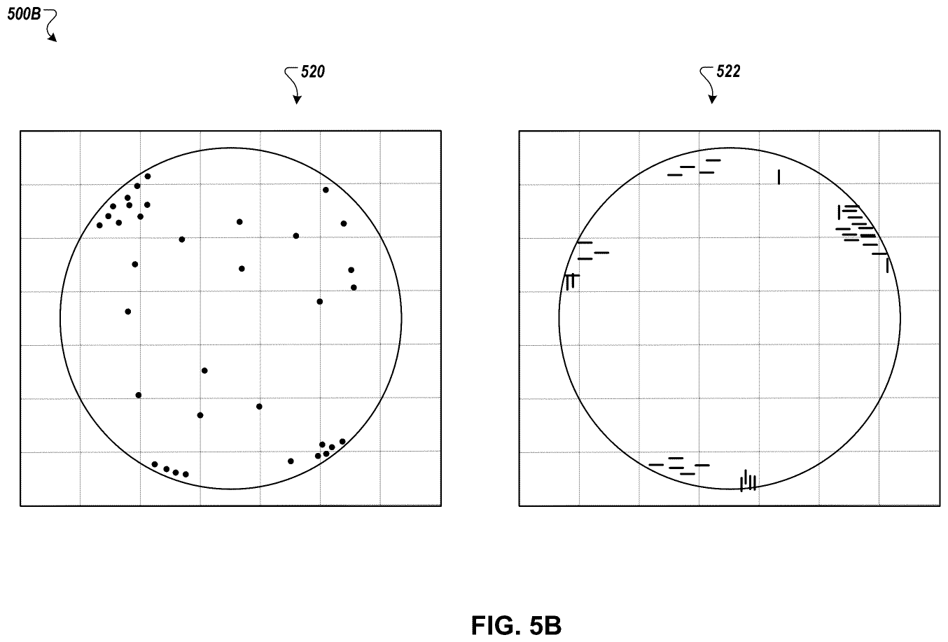

FIG. 5A is a block diagram of a flow 500A for generating epitaxial film defect data, according to some embodiments. Flow may begin in an epitaxial chamber 502, e.g., a process chamber of a manufacturing system configured to deposit an epitaxial film on a substrate (e.g., semiconductor wafer). In epitaxial chamber 502, one or more layers of epitaxial film may be deposited on the substrate. One or more materials may be deposited on the substrate. In some embodiments, the substrate with the epitaxial film may further be etched, e.g., to decorate the substrate. In some embodiments (e.g., when the substrate is designed to be etched after one or more epitaxial film deposition operations, before being provided for additional substrate processing), the substrate may be a substrate that is to be manufactured into a final device, a usable/commercial semiconductor, or the like. In some embodiments, the substrate may be a test substrate, e.g., for characterizing manufacturing equipment, a manufacturing recipe, substrate design, substrate materials, or the like.

Flow continues to one or more imaging tools 504. The imaging tools may be part of a metrology system. The imaging tools may be part of a standalone metrology system, integrated metrology system, in-line metrology system, or the like. The imaging tools may include optical imaging tools, electron microscopy tools, etc. Imaging tools 504 may be utilized to generate one or more images of the substrate. The images may include images of an entire surface of the substrate. The images may include images of a portion of the surface of the substrate. The images may include images of target portions of the substrate with different properties (e.g., different distances from the center) to improve predictions based on the images.

Flow continues to image processing 506. Image processing may proceed through an image processing flow including preprocessing 510, feature detection 512, batch processing 514, and defect counts 516. Instead or additionally, image processing may proceed via machine learning processing 518. In some embodiments, output of the image processing flow may be utilized to improve machine learning processing 518, such as providing labeled training data for machine learning processing 518.

Preprocessing 510 may include any operations for adjusting the image data for improved feature detection, epitaxial film defect detection, epitaxial defect predictions, or the like. Preprocessing may include, for example, noise reduction, one or more domain transformations, filtering, smoothing, thresholding, etc., for improving image quality and/or improving epitaxial defect determination. Feature detection 512 may include operations for identifying features in the image data that are indicative of epitaxial defects, such as etch pits, cross hatching, etc.

Batch processing 514 may include performing processing of a large number of images. A large number of images may be associated with a single substrate. For example, imaging a single substrate at a resolution appropriate for epitaxial film defect detection may include generating thousands of images. A large number of images may be associated with multiple substrates.

Defect counts 516 may include calculating number of detected defects, classifying detected defects into types, calculating local or global defect densities, etc.

Machine learning processing 518 may be used to generate similar results as the image processing flow. Machine learning processing 518 may be used in addition to or instead of the image processing flow. Machine learning processing 518 may be utilized to generate output data based on images generated by imaging tool 504. Machine learning processing 518 may generate predictive results, such as predictive defect densities, locations, maps, or the like, in portions of the substrate that are not represented in the imaging data. Machine learning processing 518 may generate predictions of causes of epitaxial defects, recommended corrective actions, etc.

Flow may continue to user interface 508. User interface 508 may include a graphical user interface, e.g., for presenting results of the epitaxial defect determination to a user. User interface 508 may include one or more interactive elements. User interface 508 may include data presentation. User interface 508 may include one or more visualizations, such as visualizations of detected and/or predicted epitaxial defects. User interface 508 may include capability of providing one or more alerts to a user, e.g., indicative of epitaxial defect count, global density, and/or local density satisfying a threshold condition, indicative of recommended corrective actions, etc.

FIG. 5B is an example epitaxial defect map 500B of a substrate, according to some embodiments. Epitaxial defect map 500B may be provided to a user via a user interface. Epitaxial defect map 500B may provide information to a user indicative of epitaxial defect density, location, severity, classification, etc., efficiently. Further information may also be presented via the user interface, e.g., numerical values of defect count and density, coordinate locations of defects, etc.

Epitaxial defect map 500B includes information indicative of locations of defects of a target substrate. Etch pit map 520 includes indications of etch pits detected by an epitaxial defect determination system. Cross hatch map 522 includes indications of cross hatching detected by an epitaxial defect determination system. One or more features of determined epitaxial defects may be presented by epitaxial defect map 500B. For example, severity or size of a defect may be indicated by color, pattern, shape, size, orientation, etc., of a element indicating a defect.

Etch pit map 520 and cross hatch map 522 may include visual representations of the target substrate. Etch pit map 520 and cross hatch map 522 may further include visual representations of respective types of epitaxial defects. In some embodiments, the locations of the epitaxial defects represented in epitaxial defect map 500B may be measured, e.g., determined by an epitaxial defect detection and/or classification procedure. In some embodiments, one or more of the epitaxial defect representations may be predictions, e.g., based on measured positions of defects in other regions of the substrate.

Cross hatch map 522 includes a set of indicators of determined cross hatching of the target substrate. In some embodiments, one or more characteristics of indicators may be related to orientation of a determined cross hatching. For example, vertical orientation of an indicator may indicate vertically aligned cross hatching, horizontal orientation of an indicator may indicate horizontally aligned cross hatching, etc. In some embodiments, one or more characteristics of an indicator may be associated with a frequency-domain filtering performed to determine the defect. In some embodiments, one or more characteristics of a visual indicator of epitaxial defect map 500B may be associated with a feature detection technique. For example, as show in epitaxial defect map 500B, a circular defect visual indicator may be associated with a frequency-domain filter configured to detect etch pits, or defects determined using a feature detection technique for detecting etch pits (e.g., Hogue transformation). As a further example, a line visual indicator may indicate an epitaxial defect detected utilizing a frequency domain filter and/or a feature detection technique associated with cross hatching. An orientation of the linear visual indicator may indicate a horizontal or vertical frequency domain filter, a horizontal or vertical cross hatching, a horizontal or vertical feature detection (e.g., contour counting), or the like.

Epitaxial defect map 500B may provide a user with easily accessible information, such as types of defects found on a substrate, concentration of defects in particular regions of a substrate, differences in distribution of different classes of defect on the substrate, an indication of defect density across the substrate or across one or more target areas of the substrate, radial and/or angular distribution of defects, etc.

In some embodiments, a user interface may provide numerical representations, color representations, pattern representations, or other representations of epitaxial defects of a substrate. In some embodiments, a user interface may provide a spatial breakdown of defect locations, e.g., by providing densities and/or counts of defects in various zones of a substrate, such as a central zone, edge zone, intermediate zone, etc. The user interface may further provide angular distributions of epitaxial defects in the substrate.

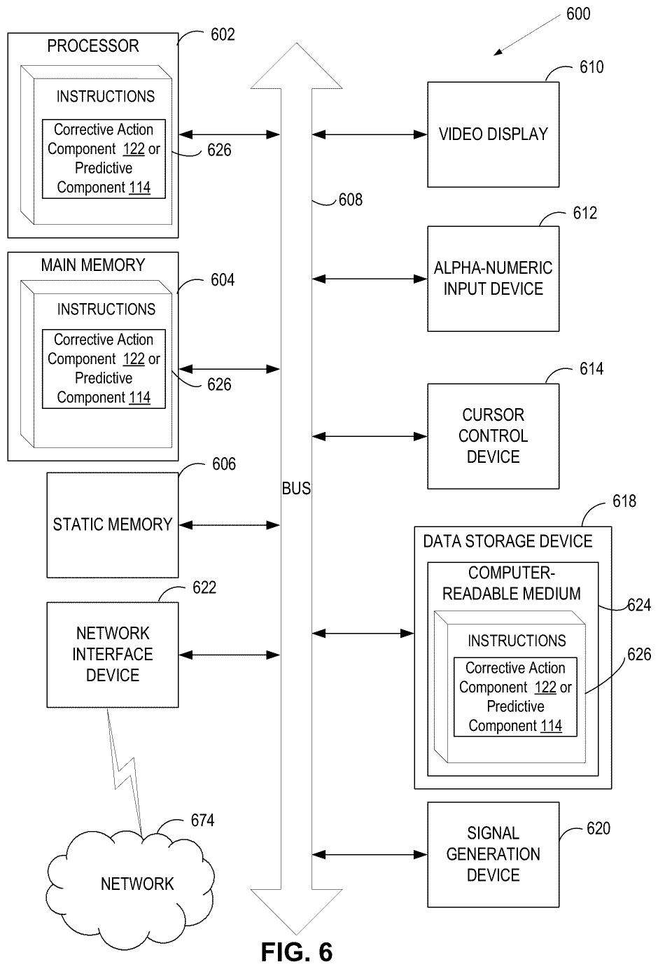

FIG. 6 is a block diagram illustrating a computer system 600, according to some embodiments. In some embodiments, computer system 600 may be connected (e.g., via a network, such as a Local Area Network (LAN), an intranet, an extranet, or the Internet) to other computer systems. Computer system 600 may operate in the capacity of a server or a client computer in a client-server environment, or as a peer computer in a peer-to-peer or distributed network environment. Computer system 600 may be provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 600 may include a processing device 602, a volatile memory 604 (e.g., Random Access Memory (RAM)), a non-volatile memory 606 (e.g., Read-Only Memory (ROM) or Electrically-Erasable Programmable ROM (EEPROM)), and a data storage device 618, which may communicate with each other via a bus 608.

Processing device 602 may be provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

Computer system 600 may further include a network interface device 622 (e.g., coupled to network 674). Computer system 600 also may include a video display unit 610 (e.g., an LCD), an alphanumeric input device 612 (e.g., a keyboard), a cursor control device 614 (e.g., a mouse), and a signal generation device 620.

In some embodiments, data storage device 618 may include a non-transitory computer-readable storage medium 624 (e.g., non-transitory machine-readable medium) on which may store instructions 626 encoding any one or more of the methods or functions described herein, including instructions encoding components of FIG. 1 (e.g., predictive component 114, corrective action component 122, model 190, etc.) and for implementing methods described herein.

Instructions 626 may also reside, completely or partially, within volatile memory 604 and/or within processing device 602 during execution thereof by computer system 600, hence, volatile memory 604 and processing device 602 may also constitute machine-readable storage media.

While computer-readable storage medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “performing,” “providing,” “obtaining,” “causing,” “accessing,” “determining,” “adding,” “using,” “training,” “reducing,” “generating,” “correcting,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may include a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and embodiments, it will be recognized that the present disclosure is not limited to the examples and embodiments described. The scope of the disclosure should be determined with reference to the following claims, along with the full scope of equivalents to which the claims are entitled.

What is claimed is:

1. A method, comprising:
obtaining, by a processing device, first image data of a substrate comprising an epitaxial film;
applying a frequency domain filter to the first image data to obtain filtered image data;
determining a number of epitaxial defects represented in the first image data by performing feature detection on the filtered image data; and
performing a corrective action in view of the number of epitaxial defects.

2. The method of claim 1, wherein performing the feature detection comprises performing one or more of a Hough transform or contour counting.

3. The method of claim 1, wherein the epitaxial defects comprise one or more of etch pits or cross hatching.

4. The method of claim 1, wherein the epitaxial film comprises one or more of:
silicon;
carbon;
boron;
arsenic;
antimony;
tin;
phosphorus;
silicon-germanium;
silicon carbide;
gallium nitride;
aluminum nitride;
gallium arsenide;
gallium aluminum nitride;
indium; or
silicon arsenide.

5. The method of claim 4, wherein the epitaxial film comprises a silicon/silicon-germanium superlattice.

6. The method of claim 1, wherein generating the first image data comprises:
depositing the epitaxial film on a substrate;
performing etching of the epitaxial film; and
capturing an image of the substrate using optical microscopy, scanning electron microscopy, or transmission electron microscopy.

7. The method of claim 1, wherein the corrective action comprises screening the substrate for additional processing.

8. The method of claim 1, wherein the corrective action comprises one or more of:
scheduling maintenance of a process chamber associated with the epitaxial film;
updating a process recipe;
updating one or more manufacturing parameters of the process chamber; or
providing an alert to a user.

9. The method of claim 1, wherein the frequency domain filter comprises one of:
a two-dimensional high-pass filter; or
a low-pass filter.

10. The method of claim 1, further comprising one or more of classifying the epitaxial defects or determining a density of epitaxial defects.

11. A non-transitory machine-readable storage medium storing instruction which, when executed, cause a processing device to perform operations comprising:
obtaining first image data of a substrate comprising an epitaxial film;
applying a frequency domain filter to the first image data to generate filtered image data;
determining a number of epitaxial defects represented in the first image data by performing feature detection on the filtered image data; and
performing a corrective action in view of the number of epitaxial defects.

12. The non-transitory machine-readable storage medium of claim 11, wherein the epitaxial defects comprise one or more of etch pits or cross hatching.

13. The non-transitory machine-readable storage medium of claim 11, wherein the epitaxial film comprises one or more of:
silicon;
carbon;
boron;
arsenic;
antimony;
tin;
phosphorus;
silicon-germanium;
silicon carbide;
gallium nitride;
aluminum nitride;
gallium arsenide;
gallium aluminum nitride;
indium; or
silicon arsenide.

14. The non-transitory machine-readable storage medium of claim 11, wherein generating the first image data comprises:
depositing the epitaxial film on a substrate;
performing etching of the epitaxial film; and
capturing an image of the substrate using optical microscopy, scanning electron microscopy, or transmission electron microscopy.

15. The non-transitory machine-readable storage medium of claim 11, wherein the corrective action comprises one or more of:
screening the substrate for performance of additional process operations;
scheduling maintenance of a process chamber;
updating a process recipe;
updating one or more manufacturing parameters of the process chamber; or
providing an alert to a user.

16. The non-transitory machine-readable storage medium of claim 11, wherein the frequency domain filter comprises one of:
a two-dimensional high-pass filter; or
a low-pass filter.

17. A system, comprising memory and a processing device coupled to the memory, wherein the processing device is configured to:
obtain first image data of a substrate comprising an epitaxial film;
apply a frequency domain filter to the first image data to obtain filtered image data;
determine a number of epitaxial defects represented in the first image data by performing feature detection on the filtered image data; and
perform a corrective action in view of the number of epitaxial defects.

18. The system of claim 17, wherein the corrective action comprises one or more of:
screening the substrate for performance of additional process operations;
scheduling maintenance of a process chamber;
updating a process recipe;
updating one or more manufacturing parameters of the process chamber; or
providing an alert to a user.

19. The system of claim 17, wherein the processing device is further to train a machine learning model to determine a number of epitaxial defects of a target substrate, by providing the first image data as training input and the number of epitaxial defects as target output.

20. The system of claim 17, wherein the epitaxial film comprises one or more of:
silicon;
carbon;
boron;
arsenic;
antimony;
tin;
phosphorus;
silicon-germanium;
silicon carbide;
gallium nitride;
aluminum nitride;
gallium arsenide;
gallium aluminum nitride;
indium; or
silicon arsenide.
